(19) United States
(12) Patent Application Publication
(10) Pub. No.: US 2020/0106064 A1
(43) Pub. Date: Apr. 2, 2020

(54) DETACHABLE COMBINED LITHIUM BATTERY POWER SUPPLY

(71) Applicant: Huizhou Zhongbang Electric Co., Ltd., Huizhou (CN)

(72) Inventors: Dexin LIANG, Huizhou (CN); Qiping XIANG, Huizhou (CN)

(21) Appl. No.: 16/510,451

(22) Filed: Jul. 12, 2019

(30) Foreign Application Priority Data
Sep. 28, 2018 (CN) 201821587829.6

(51) Int. Cl. H01M 2/10; H01M 10/052; H01M 10/613; H01M 10/6551; H01M 10/623; H01M 10/46; H01M 2/20

(52) U.S. Cl. CPC H01M 2/1066; H01M 10/052; H01M 10/613; H01M 2220/30; H01M 10/623; H01M 10/46; H01M 2/204; H01M 10/6551

(57) ABSTRACT

The present invention discloses a combined power supply, including a lithium battery and a base which are detachably connected. A power-switching circuit is provided in the base. The base further comprises a stand-by battery which is detachably connected to the base.

### CROSS-REFERENCE TO RELATED APPLICATIONS

This application claims the benefit of priority from Chinese Patent Application No. 201821587829.6, filed on Sep. 28, 2018. The content of the aforementioned application, including any intervening amendments thereto, is incorporated herein with reference in its entirety.

### TECHNICAL FIELD

The present invention relates to power supply technology, and more particularly to a combined power supply.

### BACKGROUND OF THE INVENTION

Electronic devices are widely used nowadays. The power supply for the existing electronic devices usually includes an adapter and an internal power-switching circuit. Two ends of the adapter are respectively provided with a power input interface for connecting the mains and a power output interface for supplying power to equipment. When there is a power failure, or a user in the outdoors where the mains is not available, the electronic equipment cannot be powered by these power supply units. Therefore, it is inconvenient in use, and the operational environment of the electronic equipment is limited.

### SUMMARY OF THE INVENTION

In order to overcome the above problems, the present invention provides a combined power supply, comprising a lithium battery and a base which are detachably connected. A power-switching circuit is provided in the base. The base further comprises a stand-by battery which is detachably connected to the base.

The stand-by battery is provided with a sliding groove which is connected to a sliding rail provided at the base for a detachable connection. An electrical connector is provided at an end of the stand-by battery, and an electrical connector terminal is provided at an end of the base corresponding to the stand-by battery. The electrical connector is connected to the electrical connector terminal when the sliding groove and the sliding rail are fully engaged. The stand-by battery is a lithium battery which is capable of charge and discharge cycles.

The base is an L-shaped structure, and an input terminal and an output terminal are provided at an end surface of the base. The L-shaped base comprises a protruding portion and a connecting portion. An interior of the protruding portion is a cavity and is mounted with a power-switching circuit. The power-switching circuit can be any one in the prior art, comprising an input interface configured to input the mains, a switching power supply circuit configured to convert the mains into a voltage required by an equipment, a charging and discharging management circuit configured to manage the charging and discharging of the rechargeable battery and an output interface configured to output a voltage required by the equipment.

In the combined power supply of the present invention, a detachable stand-by battery is additionally disposed on the base which can independently work. When the mains is available, the base can not only power the equipment after the mains is converted, but also charge the stand-by battery; and when the mains is not available, the equipment is powered by the stand-by battery such that a power failure of the equipment will not occur, offering convenience for users.

### BRIEF DESCRIPTION OF THE DRAWINGS

The present invention is further illustrated with reference to the accompanying drawings, but the embodiments in the accompanying drawings are not intended to limit the scope of the present invention.

FIG. 1 is a schematic diagram showing a combined power supply according to an embodiment of the present invention.

FIG. 2 is a perspective view of a lithium battery power supply according to an embodiment of the present invention.

FIG. 3 is a front view of the lithium battery power supply according to an embodiment of the present invention.

FIG. 4 is a left view of the lithium battery power supply according to an embodiment of the present invention.

FIG. 5 is a front view of a base according to an embodiment of the present invention.

FIG. 6 is a bottom view of the base according to an embodiment of the present invention.

FIG. 7 is a schematic diagram showing a combined power supply according to another embodiment of the present invention.

FIG. 8 is a front view of a base according to another embodiment of the present invention.

FIG. 9 is a bottom view of the base according to another embodiment of the present invention.

### DETAILED DESCRIPTION OF EMBODIMENTS

It should be understood that embodiments described herein are only illustrative, but not to limit the present invention.

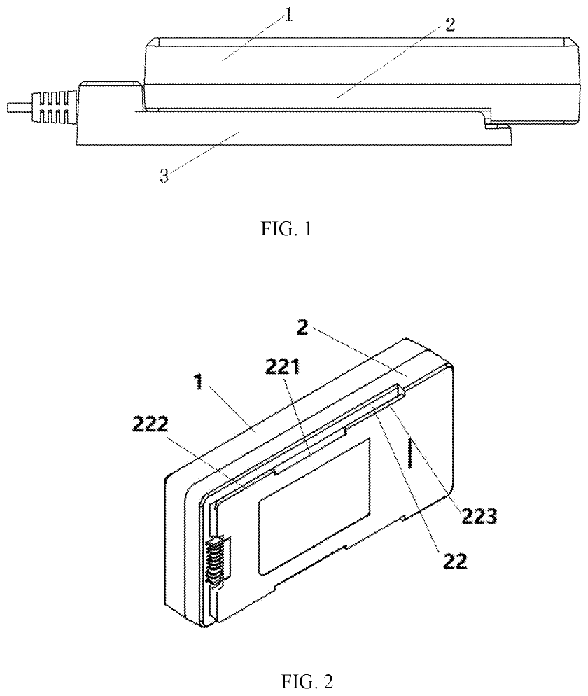

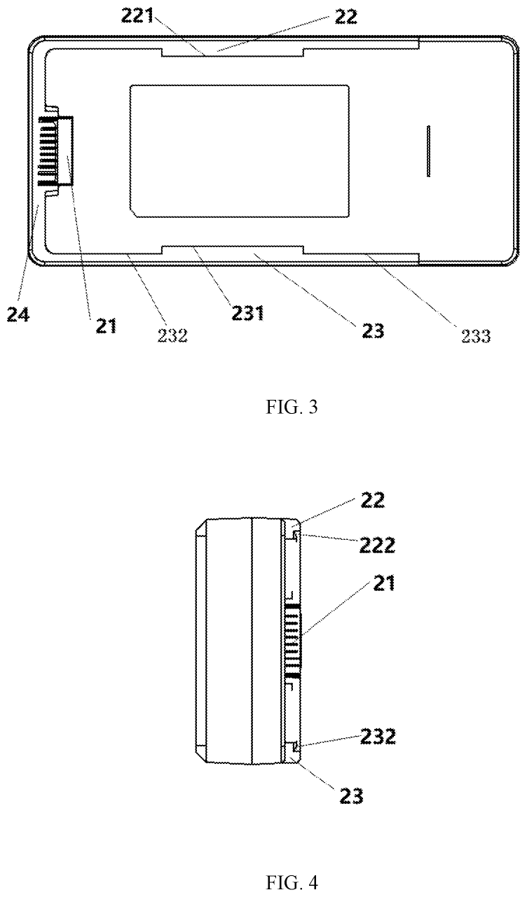

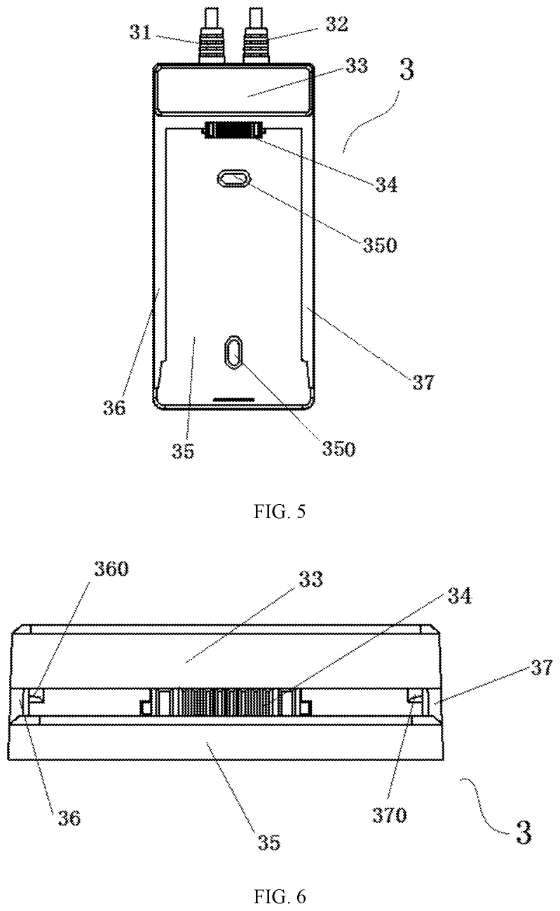

As shown in FIGS. 1-6, this embodiment provides a detachable combined lithium battery power supply, comprising a lithium battery and a base 3 which are detachably connected. The lithium battery is provided with a first engaging portion at both sides of a joint face between the lithium battery and the base. The base 3 is provided with a second engaging portion at both sides of the joint face between the lithium battery and the base. The base 3 is an L-shaped structure, and an input terminal 31 and an output terminal 32 are provided at an end surface of the base.

The lithium battery comprises an upper housing 1 and a lower housing 2. The lower housing 2 is connected to the base 3 at a surface of the lower housing away from the upper housing 1. An electrical connector 21 is provided at an end of the surface of the lower housing 2 away from the upper housing 1. A first sliding groove 22 and a second sliding groove 23 are respectively provided at two sides of the surface of the lower housing away from the upper housing. The first sliding groove 22 and the second sliding groove 23 extend along a length of the lower housing. An mounting recess 24 which is stepped is provided on the surface of the lower housing 2 away from the upper housing 1. A middle portion of the mounting recess 24 extends along a direction parallel to the length of the lower housing to form a bulge on which the electrical connector 21 is provided. The mounting recess 24, the first sliding groove 22 and the second sliding groove 23 are in a horizontal plane. The first sliding groove 22 comprises a first stopper 222, a second stopper 223 and a first notch 221. The first stopper 222 and the second stopper 223 are respectively provided at two ends of the first sliding groove 22, and the first notch 221 is provided at a middle of the first sliding groove 22. The second sliding groove 23 is symmetrically arranged with the first sliding groove 22, and the second sliding groove 23 comprises a third stopper 232, a fourth stopper 233 and a second notch 231. The first stopper 222 and the second stopper 223 protrude toward a side of the surface with respect to the first notch 221. The third stopper 232 and the fourth stopper 233 protrude toward another side of the surface with respect to the second notch 231.

The L-shaped base 3 comprises a protruding portion 33 and a connecting portion 35. A first sliding rail 36 and a second sliding rail 37 are provided at an upper surface of the connecting portion 35. The electrical connector terminal 34 is provided at a middle of a junction between the protruding portion 33 and the connecting portion 35. The connecting portion 35 further comprises a plurality of heat dissipation holes penetrating through the connecting portion.

The first sliding rail 36 and the second sliding rail 37 are respectively slidably engaged with the first sliding groove 22 and the second sliding groove 23. The lithium battery slides along the first sliding rail 36 and the second sliding rail 37 until an end of the lithium battery fits with the protruding portion 33. At this time, the electrical connector 21 and the electrical connector terminal 34 are electrically connected. A detachable mechanical connection between the stand-by battery and the base 3 can be achieved by the cooperation of the sliding grooves and the sliding rails.

In an embodiment, when the lithium battery power supply is fully engaged with the adapter body, the sliding rail of the adaptor may be provided with stoppers which are embedded in the first notch 221 and the second notch 231 of the lithium battery power supply, and the stoppers respectively abut against the first notch and the second notch to limit the lithium battery power supply.

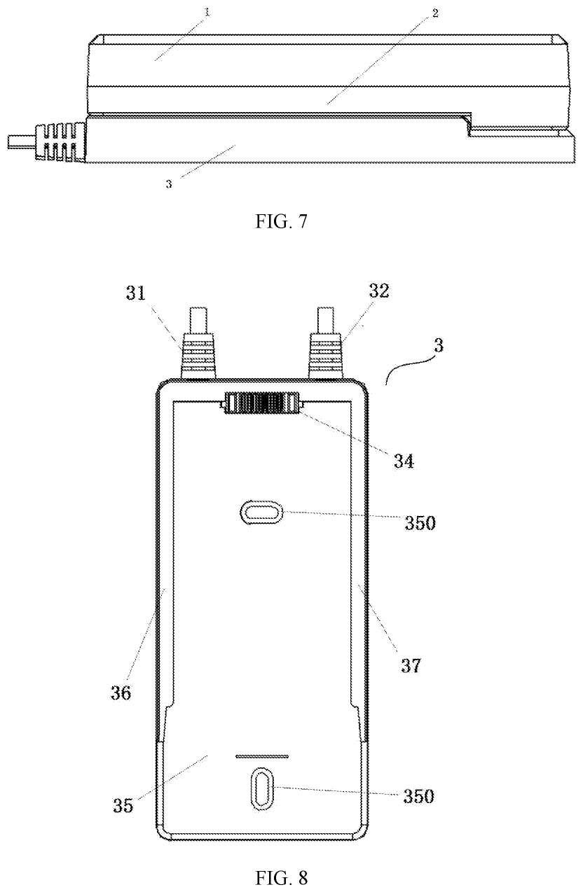

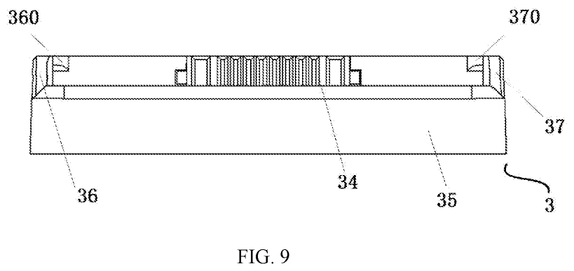

As shown in FIGS. 7-9, this embodiment provides a detachable combined lithium battery power supply, comprising a lithium battery and a base 3 which are detachably connected. The lithium battery is provided with a first engaging portion at both sides of a joint face between the lithium battery and the base. The base 3 is provided with a second engaging portion at both sides of the joint face between the lithium battery and the base. An input terminal 31 and an output terminal 32 are provided at an end surface of the base 3. The base 3 comprises a connecting portion 35. A first sliding rail 36 and a second sliding rail 37 are provided at an upper surface of the connecting portion 35. The electrical connector terminal 34 is located in the middle of the base 3 head. The connecting portion 35 further comprises a plurality of heat dissipation holes 350 penetrating through the connecting portion. The first sliding rail 36 and the second sliding rail 37 are respectively slidably engaged with the first sliding groove 22 and the second sliding groove 23. The lithium battery slides along the first sliding rail 36 and the second sliding rail 37 until an end of the lithium battery fits with the protruding portion 33. At this time, the electrical connector 21 and the electrical connector terminal 34 are electrically connected. A detachable mechanical connection between the stand-by battery and the base 3 can be achieved by the cooperation of the sliding grooves and the sliding rails.

In an embodiment, when the lithium battery power supply is fully engaged with the adapter body, the sliding rail of the adaptor may be provided with stoppers which are embedded in the first notch 221 and the second notch 231 of the lithium battery power supply, and the stoppers respectively abut against the first notch and the second notch to limit the lithium battery power supply.

The technical features of the above embodiments may be arbitrarily combined. In the above embodiment, there are only a part of the possible combinations of the technical solutions of the present invention. Therefore, any combination of the technical solutions should be included in the scope of the present invention as long as they are not contradictory.

The above embodiments described in detail are only illustrative of some implementations of the present invention, and cannot be understood as limiting. It should be noted that variations and modifications may be made by those skilled in the art without departing from the spirit of the present invention, and should fall within the scope of the present invention. Therefore, the scope of the present invention should be defined by the appended claims.

What is claimed is:

1. A detachable combined lithium battery power supply, comprising a lithium battery and a base which are detachably connected;
wherein the lithium battery is provided with a first engaging portion at both sides of a joint face between the lithium battery and the base;
the base is provided with a second engaging portion at both sides of the joint face between the lithium battery and the base for fitting with the first engaging portion;
the base is an L-shaped structure, and an input terminal and an output terminal are provided at an end surface of the base.

2. The combined power supply of claim 1, wherein the lithium battery comprises an upper housing and a lower housing; and the lower housing is connected to the base at a surface of the lower housing away from the upper housing.

3. The combined power supply of claim 2, wherein an electrical connector is provided at an end of the surface of the lower housing away from the upper housing; a sliding groove is respectively provided at both sides of the surface of the lower housing away from the upper housing; and the sliding groove extends along a length of the lower housing.

4. The combined power supply of claim 3, wherein an mounting recess which is stepped is provided at the end of the surface of the lower housing away from the upper housing.

5. The combined power supply of claim 4, wherein a middle of the mounting recess extends along a direction parallel to the length of the lower housing to form a bulge on which the electrical connector is provided.

6. The combined power supply of claim 5, wherein the mounting recess and the sliding groove are located in a horizontal plane.

7. The combined power supply of claim 1, wherein the L-shaped base comprises a protruding portion and a connecting portion; a sliding rail is respectively provided at two sides of an upper surface of the connecting portion; and an electrical connector terminal is provided at a middle of a junction between the protruding portion and the connecting portion.

8. The combined power supply of claim 7, wherein the connecting portion comprises a plurality of heat dissipation holes penetrating through the connecting portion.

9. The combined power supply of claim 1, wherein the sliding rail is slidably engaged with the sliding groove; and the lithium battery slides along the sliding rail until an end of the lithium battery fits with the protruding portion.

10. The combined power supply of claim 9, wherein the electrical connector and the electrical connector terminal are electrically connected.
